(19) United States
(12) Patent Application Publication
(10) Pub. No.: US 2008/0175168 A1
(43) Pub. Date: Jul. 24, 2008

(54) Method for Determining the Structure of a Communication Network

(76) Inventors: Bjorn Kracker, Berlin (DE); Heike Leuschner, Berlin (DE); Alfons Mittermaier, Berlin (DE)

Correspondence Address: BELL, BOYD & LLOYD, LLP, P.O. BOX 1135, CHICAGO, IL, 60690, US

(21) Appl. No.: 11/579,428

(22) PCT Filed: Mar. 22, 2005
(86) PCT No.: PCT/EP2005/051309

§ 371 Date: Jan. 2, 2008

(30) Foreign Application Priority Data
May 4, 2004 (DE) 10 2004 021 956.7

(51) Int. Cl. H04L 12/24

(52) U.S. Cl. 370/255

(57) ABSTRACT

In one aspect, a method for determining the structure of a communication network, consisting of a plurality of network elements joined by physical connections is provided. An attribute is stored at a terminal of a connection, in each network element, the attribute containing all of the information relating to the network element adjoined via the connection. The structure of the entire network is determined via the information contained in the attributes of the connection terminals.

### CROSS REFERENCE TO RELATED APPLICATIONS

This application is the US National Stage of International Application No. PCT/EP2005/051309, filed Mar. 22, 2005 and claims the benefit thereof. The International Application claims the benefits of German application No. 102004021956.7 DE filed May 4, 2004, both of the applications are incorporated by reference herein in their entirety.

### FIELD OF INVENTION

The invention relates to a method for determining the structure of a communication network consisting of a plurality of network elements and physical connections between these network elements.

### BACKGROUND OF INVENTION

By definition, a communication network is a resource, which connects service access points which are remote from one another and provides these services with service features for communication purposes.

A communication network generally breaks down into an application system and a transport network, with the transport network providing a reliable, error-free and qualitatively high-quality transport path. The application system requires this transport and interprets the transported data in order to make it accordingly accessible and useful to the subscriber.

The communication network, and in this case particularly the transport network, consists of network elements, which are connected to one another by means of physical connections.

The operation and maintenance is carried out here using systems for network management, so-called management systems. For the operation and the maintenance of the communication network, it is important here to know the setup, structure and the components of the communication network, with these however often no longer being visible after the communication network has been set up.

The methods known from the prior art, such as methods for instance which are used for data networks based on the TCP/IP internet protocol family, mostly only represent partial solutions to the problem of ascertaining the physical network structure from the network.

The methods known for data networks based on the internet-based protocol nevertheless allow the network structure to be ascertained from the network. The ascertained structure is not necessarily identical to the physical network structure. This method can thus only be used for a communication network to a restricted degree.

A method for circuit-switched telecommunication networks is known from WO01/80596, in which the network structure is determined by means of so-called trace messages during a recognition phase. This method is however disadvantageous in that such traces do not exist on a level corresponding to the physical connection between all network elements, whereby specific connections and network elements remain unrecognized.

A further known method consists in manually entering the network structure into the management system during the setup. This method is however relatively time-consuming as each subsequent network structure change must be manually re-entered into the management system.

### SUMMARY OF INVENTION

An object underlying the invention is to specify a method, with which the structure of a communication network can be determined in a simple manner from the network.

In accordance with the invention, this is carried out using a method of the type mentioned at the start, in which an attribute is stored in each network element at each terminal of a connection. This attribute has all the information relating to the network element adjoined by means of said connection. From the information contained in the attributes of the connection terminals, the structure of the communication network is then determined by means of a so-called network management system, which is used during the setup, operation and maintenance of the communication network.

The method according to the invention for determining the structure of a communication network is advantageous in that the structure of the communication network can be determined by means of a network management system, which is connected to any network element, without it being necessary to manually enter the network structure data in advance, since the information relating to the network structure in the attributes of the connection points of the network elements is always available in the communication network itself. Furthermore, very little means are necessary for implementing this method.

It is also advantageous if the attributes of the connection terminals can be mechanically read and written.

It is also favorable if a network management system is provided, which obtains the information relating to the structure of the complete network by means of the information in the attributes of the connection terminals in the network elements via the respective adjoining elements.

It is also advantageous if a network management system is available for the setup and modification of the communication network, which can write attributes of the connection terminals into the network elements.

### BRIEF DESCRIPTION OF THE DRAWINGS

The invention is described by way of example in more detail with reference to the figures, in which;

FIG. 1 shows the schematic setup of a communication network in which the method is used

FIG. 2 shows the schematic setup of the attribute

### DETAILED DESCRIPTION OF INVENTION

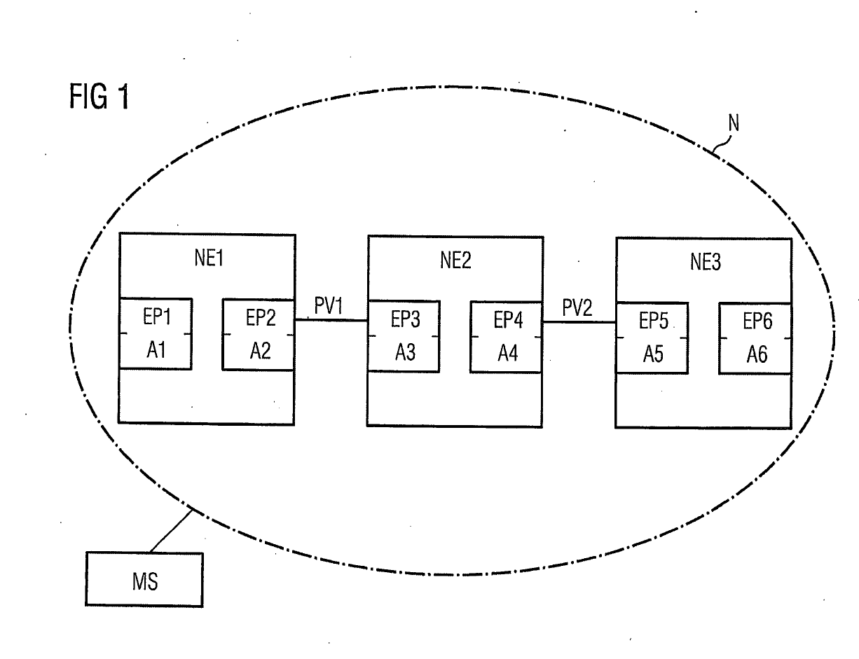

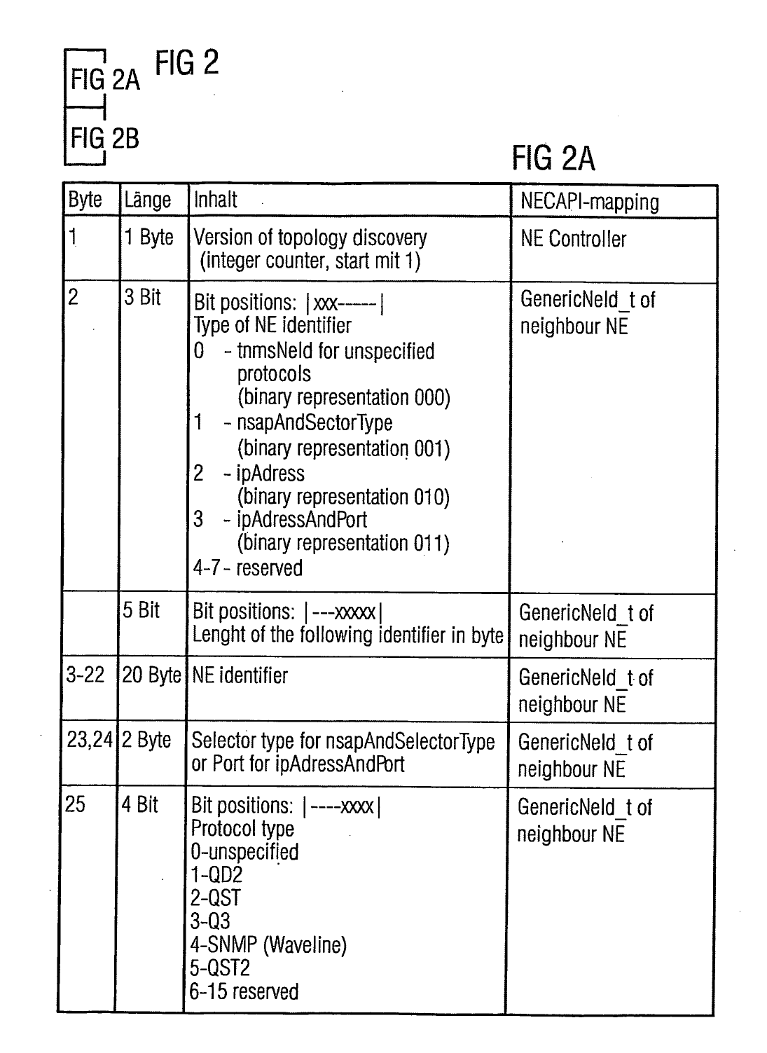

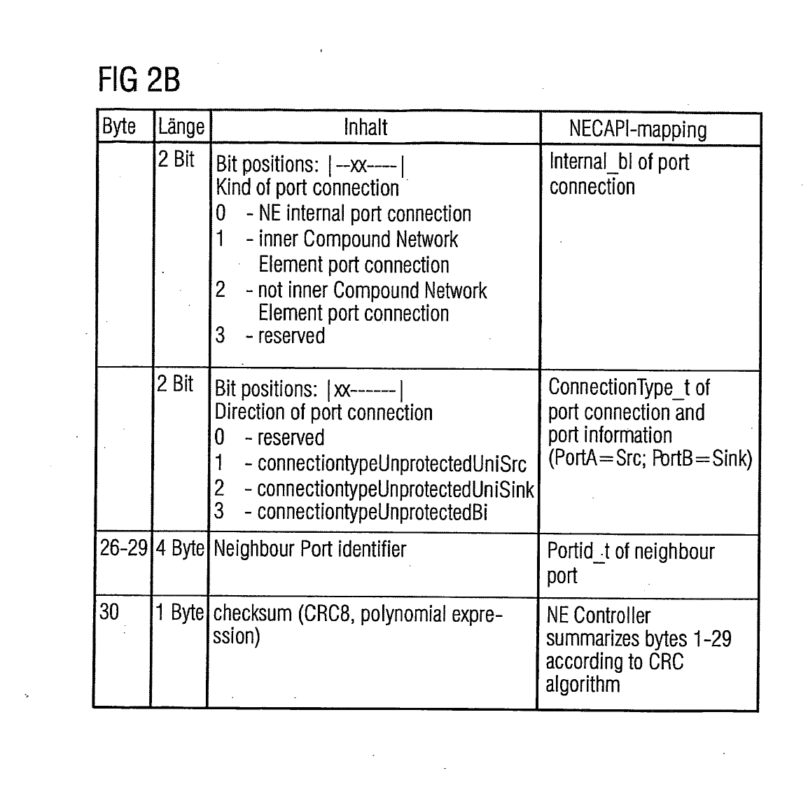

The exemplary communication network N according to FIG. 1 features several network elements NEx and physical connections PVx between the network elements NEx. The terminals EPx of the physical connections PVx exist in each network element NEx. These terminals EPx are provided with readable and writeable attributes Ax, which correspond to the setup described in FIG. 2.

Such an attribute Ax advantageously consists of 10 fields featuring the following information; the version of the structure identification, the type of the network element identifier, the network element identifier, the selector type for the OSI connections or IP connection, the protocol type, the manner and the direction of the link PVx of the data link, the identifier of the adjacent data link and the check sum.

An attribute Ax with this schematic structure is typically 30 bytes long. Nevertheless, to guarantee printable characters, a base64 encoding is used, whereupon the final length of the attribute Ax is 40 bytes. The structure of the setup of the attribute Ax results from the boundary links, which are predetermined by the existing network elements NEx in the communication networks N.

These attributes Ax contain all the information relating to the adjoining network element NEx connected by means of the respective corresponding physical connection PVx.

The network management system MS is also connected to the communication network N.

The method according to the invention proceeds as follows:

When setting up the communication network N, the two network elements NE1 and NE2 are also registered in the network management system MS and a connection is set up for both network elements. During operation, a connection PV1 between the terminals EP2 and EP3 is established in the network elements NE1 and NE2 by means of a network management system MS, the data of the network element NE2 and of the connection terminal EP3 is stored here in attribute A2 in the network element NE1 and the data of the network element NE1 and of the connection terminal EP2 is stored in the attribute A3 in the network element NE2.

If a further network element NE3 with the connection to the network element NE3 is set up in the communication network N, the network elements NE2 and NE3 are known in the network management system MS, and a connection to both also exists. The connection PV2 between the terminals EP4 and EP4 in the network elements NE2 and NE3 is established between the terminals EP4 and EP4. The data of the network element NE2 and of the connection terminal EP4 is entered here into attribute A5 in the network element NE3 and the data of the network element NE3 and of the connection terminal EP5 is entered into attribute A4 in the network element NE2.

If the structure of a communication network N is now to be identified from the network, the network management system MS must first be connected to the communication network N and be connected to network element NE1. All attributes A1 and A2 of all connection terminals EP1 and EP2 of the network element NE1 are read out by means of the network management system MS. The information contained in attributes A1 and A2 is interpreted by the network management system MS. In this process, the exemplary embodiment determines that no network element NEx is connected to the connection terminal EP1. The evaluation of the attribute A2 shows that the network element NE1 is connected to the connection terminal EP3 in the network element NE2. The network element NE2 and the connection PV1 is known from the network management system MS.

The network management system is now connected to the newly ascertained network element NE2 and the attribute A4 of the connection terminal EP4 of the network element NE2 still unknown thereto is read out.

The attribute A4 is interpreted by the network management system MS and shows that the network element NE2 is connected to the connection terminal EP5 in the network element NE3. The network element NE3 and the connection PV2 is made known in this way to the network management system MS. The structure of the communication network N in the exemplary embodiment is thus now known to the network management system MS.

1.-5. (canceled)

6. A method for determining the structure of a communication network composed of a plurality of network elements and physical connections between the network elements, comprising:
storing an attribute in each network element at each terminal of a connection; and
wherein the attribute having all the information relating to the network element adjoined via the connection and that a structure of the complete network is determined by way of the information contained in the attributes of the connection terminal.

7. The method according to claim 6, wherein a base64 encoding is used for the attribute and the length of the attribute is 40 bytes.

8. The method according to claim 6, wherein the attribute is mechanically read out and written.

9. The method according to claim 8, further comprises providing a network management system that obtains the information relating to the structure of the complete network via of the information in the attributes of the connection terminal in the network elements via the respective adjoining elements.

10. The method according to claim 9, characterized in that the network management system writes the attributes of the connection terminals in the network elements during a setup and a modification of the communication network.

11. The method according to claim 10, wherein a base64 encoding is used for the attribute and the length of the attribute is 40 bytes.

12. A method for determining the structure of a communication network composed of a plurality of network elements and physical connections between the network elements, comprising:
storing an attribute in each network element at each terminal of a connection, the attribute having information relating the network element adjoined via the connection; and
providing a network management system that obtains information relating to a structure of the complete network via of the information in the attributes.

13. The method according to claim 12, wherein the network management system writes the attributes of the connection terminals in the network elements during a setup and a modification of the communication network.

14. The method according to claim 12, wherein the attribute is encoded to provide printable characters.

15. The method according to claim 14, wherein the encoding is a base 64 encoding.

16. The method according to claim 15, wherein the encoded attribute has a length of 40 bytes.

17. The method according to claim 14, wherein the network management system writes the attributes of the connection terminals in the network elements during a setup and a modification of the communication network.
